(19) United States
(12) Patent Application Publication
(10) Pub. No.: US 2008/0237176 A1
(43) Pub. Date: Oct. 2, 2008

(54) Nursing Bottle Air-Inlet Regulating Valve

(76) Inventor: Ramiro Pillado, Buenos Aires (AR)

Correspondence Address: AKERMAN SENTERFITT, P.O. BOX 3188, WEST PALM BEACH, FL, 33402-3188, US

(21) Appl. No.: 12/034,205

(22) Filed: Feb. 20, 2008

Related U.S. Application Data
(63) Continuation-in-part of application No. 11/356,609, filed on Feb. 17, 2006.

(30) Foreign Application Priority Data
Feb. 18, 2005 (AR) P20050100602

(51) Int. Cl. A61J 9/04; A61J 9/00

(52) U.S. Cl. 215/11.5; 215/11.1

(57) ABSTRACT

A nursing bottle air-inlet regulating valve comprising a flat elastomeric valve (1) that lies on the inner part of a threaded base (2) of a nursing bottle body (3) and comprises small domes (4) on fee upper side (where the liquid is). The domes (4) have a slit (5), through which air flows to balance the pressure in the nursing bottle. Vent channels (8) are included on the Underside of the membrane, which is the side the membrane contacts the threaded base (2) of the nursing bottle. The membrane (1) has a perimeter wall or edge (9) that fits in the inner perimeter of the threaded base (2), continuing in a hollow perimeter channel (7) allowing air to circulate when the base (2) is unthreaded. The domes (4) are connected to the perimeter channel by the vent channels (8). Air-inlet flow is regulated by how much the vent channels (8) are squashed. The vent channels (8) allow the air to flow from outside the nursing bottle towards the domes, through the communicating channels that open to the outside when partially unthreading the threaded base (2) of the nursing bottle, the base (2) having a series of openings through which atmospheric air flows.

### CROSS-REFERENCE TO RELATED APPLICATIONS

This application is a continuation-in-part (CIP) of U.S. patent application Ser. No. 11/356,609 filed on Feb. 17, 2006, the entirety of which is incorporated herein by reference in its entirety.

### BRIEF DESCRIPTION OF THE INVENTION

The present invention refers to nursing bottles, more specifically to nursing bottles having air-inlet regulating devices comprising a valve configured to such effect.

The proposed valve allows the regulation, as necessary, of air inside the nursing bottle, avoiding the creation of an unbalanced air pressure in the nursing bottle when the baby is sucking on the nipple. As air is allowed into the body, the air-inlet regulating device means that pressure is no longer unbalanced in the bottle body and the outlet flow of liquid is increased. In this manner it is possible to regulate the liquid flow that the baby is drinking.

### PRIOR ART

Traditional nursing and baby bottles only have one discharge outlet for the liquid at the nipple and do not provide for any air inlet. The problems posed by these nursing bottles amply disclosed in prior art are well known: as the baby sucks an imbalance in the pressure in the body of the nursing bottle is produced, causing the liquid to flow unsteadily and the Infant swallows a lot more liquid leading to indigestion.

Taking this problem into account, the prior art developed nursing bottles having valves allowing air inlet from the threaded base of the nursing bottles body. Some of these valves are disclosed in U.S. Pat. Nos. 5,339,971, 5,499,729 and 5,431,290.

Most of these nursing bottles provide valves for air-inlet that generally comprise nipples with openings or slits coinciding with air-inlet openings provided on the threaded base of the nursing bottle, such that when the infant suctions the liquid through the nipple, an imbalance of pressure Is generated in the bottle and the openings or slits in the nipple allow air in to avoid a vacuum forming In the bottle. When the nursing bottle is at rest, the pressure of the liquid inside the nipple causes the slits to close and stops the liquid from flowing out.

However notwithstanding, a new problem that has arises with these configurations is that although the liquid does not flow unsteadily, but continuously, the outflow of liquid is sometimes too great as regards the adequate amount the infant can drink, especially newborns.

The excessive liquid flow can cause choking or can cause the infant to drink the liquid too fast and suffer indigestion, which causes discomfort for the infant and inconvenience for the caregiver.

The present application, therefore, provides a valve that allows the regulation of the air-inlet flow into the bottle, indirectly regulating the liquid outlet flow drunk by the infant.

### BRIEF DESCRIPTION OF THE DRAWINGS

FIG. 1 shows a view in perspective from above of the valve

FIG. 2 is a view in perspective from below of the same valve.

FIG. 3 shows a view in perspective from above of the valve inserted in the bottle's threaded base.

FIG. 4 is a cross-section of the valve in an open position, with the base of the bottle slightly unthreaded.

FIG. 5 shows another cross-section of the valve but in a closed position thereof, with the threaded base of the bottle completely closed.

FIG. 6 shows a view in perspective from above of the threaded base without the valve or membrane included.

FIG. 7 is a view in perspective from below of the same threaded base of FIG. 6, showing the air-inlet openings.

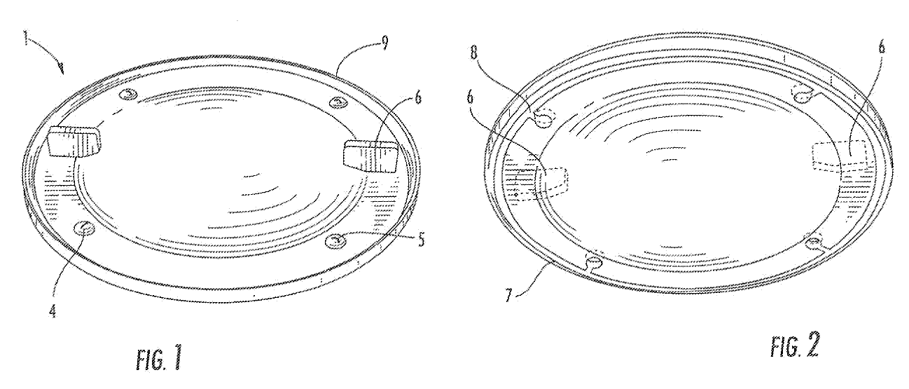

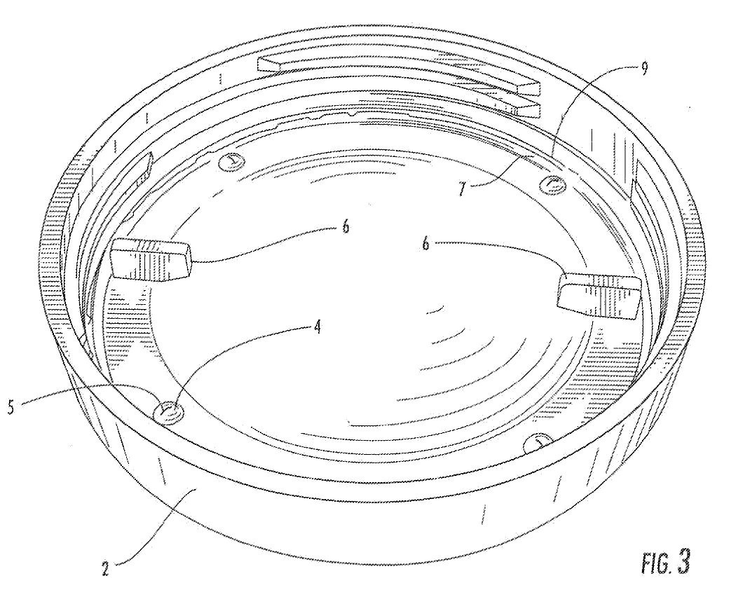

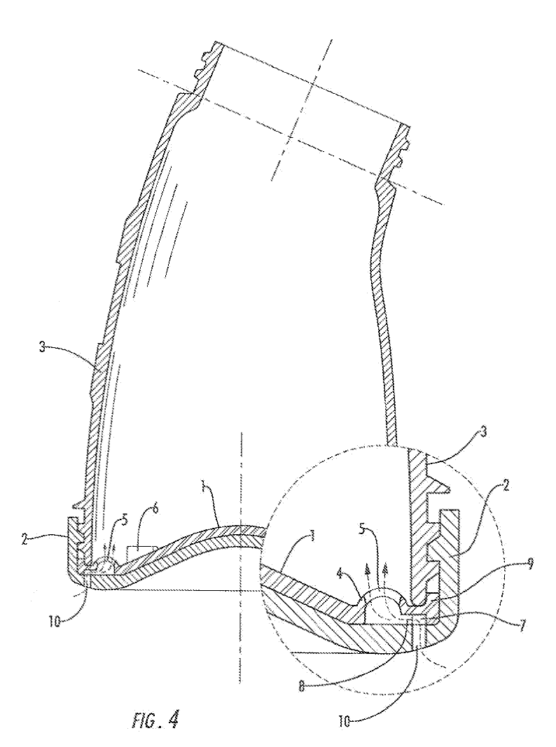

### DETAILED DESCRIPTION OF THE INVENTION

The proposed valve (1) is an elastomeric valve which comprises a slightly concave circular membrane placed on the inside of the threaded base (2) of the nursing bottles body, (3) comprises small domes (4) on the inner or upper side (where the liquid is). The domes (4) have a slit (5) at the end, through which air flows when there is an imbalance of pressure in the bottle.

The valve (1) membrane on the outer side (facing the domes, where there is no liquid) comprises vent channels (8). This outer or lower side of the membranes is the one contacting the threaded base (2) of the bottle. Preferably there are four of said vent channels (8).

The circular membrane comprises a perimeter wall or edge (9) that fits in the inner perimeter of the threaded base (2), continuing with a hollow perimeter channel (7) that allows air to circulate when the base (2) is unthreaded. The domes (4) are connected to the perimeter channel (7) by the vent channels (8) that complete air-inlet flow. The air inlet flow is regulated according to how much the vent channels (8) are squashed when the base (2) is threaded.

These vent channels (8) allow air to flow from outside the nursing bottle towards the domes, through a series of openings (10) in the bottles threaded base (2), these openings being the air-inlet for atmospheric air. This series of openings (10) are located in the perimeter of the threaded base, coinciding with the hollow perimeter of the channel (7) of the valve (1) membrane. The openings allow the air to enter the bottle from the outside, balancing the pressure that has been unbalanced by the infant's suction.

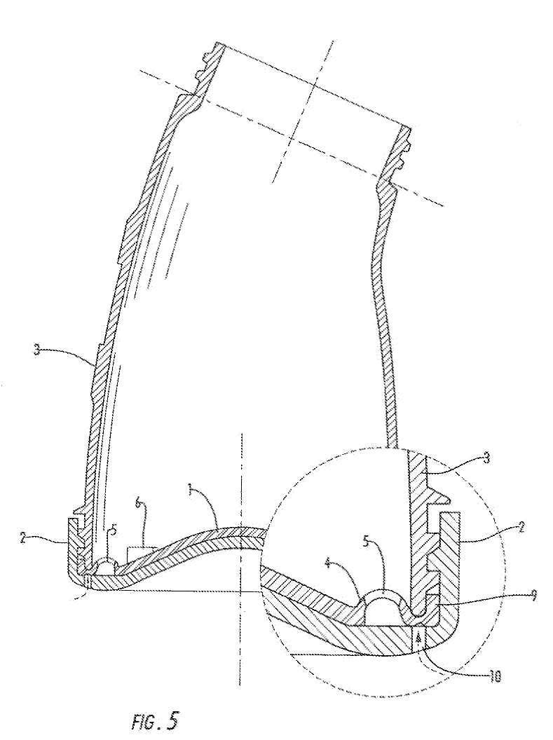

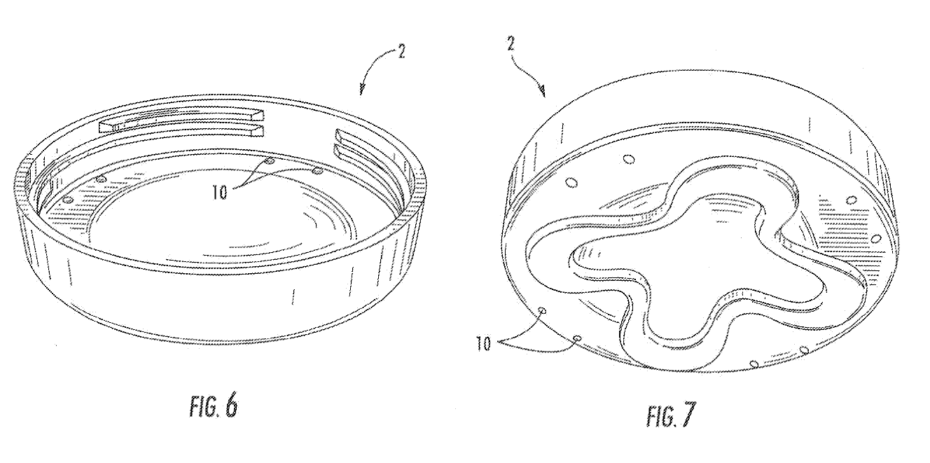

As the valve (1) membrane is made of silicone or any other elastomers, it is resilient and can be squashed or deformed, such that the person who is feeding the child or baby can regulate the liquid flow that the baby drinks by partially threading or unthreading the base (2) of the nursing bottle (3). When said base (2) is threaded, the valve (1) is squashed against the edge of the bottle (FIG. 5), this pressure causes the vent channels (8) to begin to collapse, partially or totally limiting the air flow into the nursing bottle (3).

As more force is applied on the threading (2), the air flow is further closed leading to total closure, where the valve (1) no longer works as such, as no air enters the bottle. Complete closure is produced when the vent channels (8) have completely collapsed; therefore, air has no way of entering the nursing bottle (FIG. 5). Then, if the base (2) is unthreaded a bit, the vent channels (8) begin to recover their shape and allow air into the bottle (FIG. 4). As air enters, the pressure is balanced in the bottle and the outward liquid flow increases, in this manner it is possible to regulate the liquid flow that the baby drinks.

The valve membrane (1) comprises preferably two upright walls (6) which are slender and have a height which is similar to the total height of the membrane. These two upright walls (6) allow the removal of the membrane (1) when the bottle is to be washed. This presents an additional advantage because prior art nursing bottles membranes are normally removed with puncturing objects, such as knives, forks, etc., which can easily slip and cause damage to the membranes.

This proposed embodiment of regulating valve with deformable vent channels, aids in preventing the baby from drinking liquid too fast as with traditional valves, favouring a better digestion.

Another advantage that the proposed valve has, compared to the known prior art, refers to the way of heating the liquid in the nursing bottle. The use of the microwave oven to heat food to be ingested by a baby, including a nursing bottle with milk, is known to be rejected by part of society; for which reason bottles are often heated in a double boiler, i.e., by placing the bottle in a jug of boiling water on a stove top. The proposed valve that allows the regulation of inlet of air to die bottle, is able to be heated in the manner described without mining the risk that the content of the bottle gets mixed with boiling water; as it will be sufficient to completely close the threaded base (2) of the bottle to achieve desired airtightness. The known bottle models have air vents that are always open thus running the risk that hot water will flow through the air-inlets and mix with the content of the nursing bottle.

When putting the described nursing bottles air-inlet regulating valve into practice, modifications and/or variations could be introduced, all of which would be considered to be comprises within the scope of the present invention; said scope being determined basically, by the text of the claims below.

We claim:

1. A nursing bottle air-inlet regulating valve comprising:
an elastomeric resilient membrane with hollow domes having a slit and a threaded base with air-inlet openings,
wherein the membrane comprises a perimeter edge that fits in the timer perimeter of said threaded base of the nursing bottle and has a hollow perimeter channel communicating with the vent channels in the membrane on its underside that contacts the threaded base of the nursing bottle.

2. The nursing bottle air-inlet regulating valve according to claim 1, wherein said vent channels are deformable.

3. The nursing bottle air-inlet regulating valve according to claim 1, wherein the domes are connected to the perimeter channel through said vent channels that complete the air-inlet inlet flow.

4. The nursing bottle air-inlet regulating valve according to claim 1, wherein there are at least two air-inlet openings in the threaded base.

5. The nursing bottle air-inlet regulating valve according to claim 1, wherein said membrane comprises at least an upright wall.
